(19) United States
(12) Patent Application Publication
(10) Pub. No.: US 2010/0007156 A1
(43) Pub. Date: Jan. 14, 2010

(54) Glove box striker with box clip attachment feature

(76) Inventors: Aaron D. Pokowski, St. Clair Shores, MI (US); Michael Vanderzwaag, Hamilton (CA)

Correspondence Address: MCDONALD HOPKINS LLC, 600 Superior Avenue, East, Suite 2100, CLEVELAND, OH, 44114-2653, US

(21) Appl. No.: 12/322,051

(22) Filed: Jan. 28, 2009

Related U.S. Application Data
(60) Provisional application No. 61/062,591, filed on Jan. 28, 2008.

(51) Int. Cl. E05B 15/02

(52) U.S. Cl. 292/340

(57) ABSTRACT

The present invention provides a striker with a box clip feature. The striker may be mounted to a support structure for engagement with a latch mechanism. The striker may include a body for mounting to a support structure, such as an instrument panel in a vehicle. The striker may include a latch bar capable of engaging the latch mechanism. The striker may also include a locating feature that may aid in alignment within the support structure for quick assembly. The box clip feature may include an aperture that is capable of connecting said body to the support structure.

### CROSS-REFERENCE TO RELATED APPLICATION

This application claims benefit from U.S. Provisional Patent Application No. 61/062,591, entitled “Glove Box Striker With Box Clip Attachment Feature,” filed on Jan. 28, 2008, which is hereby incorporated in its entirety by reference.

### FIELD OF THE INVENTION

The present invention is generally related to a glove box door latch mechanism for a vehicle and, more particularly, to a glove box striker with an integrated box clip feature.

### BACKGROUND OF THE INVENTION

A variety of latching mechanisms are known in the art and are used within the automotive industry for releasably coupling various movable components to the vehicle body. For example, latches L are used for releasably coupling doors (e.g. passenger doors, liftgate, hood, trunk, glove box, etc.) to vehicles. The latching mechanisms L are generally operable in a latched mode to secure the door to the vehicle body and in an unlatched mode where the door is freely movable relative to the vehicle body. The latching mechanisms typically include a latch L that engages a striker S when the door is in a closed position. The latch is typically secured near an edge of the door, and a striker S is typically secured to the vehicle body.

It is known in the art to provide a glove box door or handle H that closes an opening, such as a glove box or storage area, in an instrument panel P of a vehicle. The glove box door is hingedly mounted to the instrument panel P to allow for pivotal movement between a closed position and an open position. In order to keep the door or handle H of the glove box in the closed position, a latching mechanism L is provided.

Typically, the latching mechanism L includes a striker S to be mounted to the instrument panel P structure. As seen in FIGS. 1 and 3, prior art strikers S have a latch bar L for the glove box latch to “strike” and close around. A striker bar B for latching the glove box door in a closed position is typically fixed to the instrument panel P facing the surface of the door. A hinge typically connects the door to the instrument panel P, each half of the hinge having separate connections. A claw mechanism L is also typically mounted to the glove box door. The claw mechanism traps or catches the latch bar B of the striker S when the glove box door is in the closed position.

These prior art strikers S often require secondary operations as well as additional fastener components to function properly. Specifically, current glove box strikers require weld nuts WN to aid in attaching the striker S to the instrument panel P of the vehicle. Therefore, there is a need in the art to provide an improved glove box striker that speeds up assembly time and reduces the number of additional components and secondary operations needed, thereby reducing cost.

### DESCRIPTION OF THE DRAWINGS

Operation of the invention may be better understood by reference to the following detailed description taken in connection with the following illustrations, wherein:

FIG. 1 illustrates a perspective view of a prior art glove box striker.

FIG. 2 illustrates a perspective view of a prior art glove box striker.

FIG. 3 illustrates a perspective view of a prior art glove box striker.

FIG. 4 illustrates a perspective view of a prior art box clip.

FIG. 5 illustrates a perspective view of a glove box striker in accordance with an embodiment of the invention.

FIG. 6 illustrates a top view of the glove box striker.

FIG. 7 illustrates a section view taken along line A-A of FIG. 6.

FIG. 8 illustrates a close up section view taken along line B-B of the box clip portion of FIG. 6.

FIG. 9 illustrates another perspective view of the glove box striker.

FIG. 10 illustrates a perspective view of the box clip portion of the glove box striker engaged with a fastener.

### SUMMARY OF THE INVENTION

A striker for mounting to a support structure and for engagement with a latch mechanism. The striker may include a body having a first end and a second end. The body may have an aperture for connecting the base to the support structure. The striker may include a latch bar located on the first end. The striker may also include at least one locating feature extending outwardly from the second end, wherein the locating feature may be capable of engaging a support structure. The striker may further include an attachment feature capable of engaging the support structure.

### DETAILED DESCRIPTION

While the invention is described herein with reference to several embodiments, it should be clear that the invention should not be limited only to the embodiments disclosed or discussed. The description of the embodiments herein is illustrative of the invention and should not limit the scope of the invention as described or claimed.

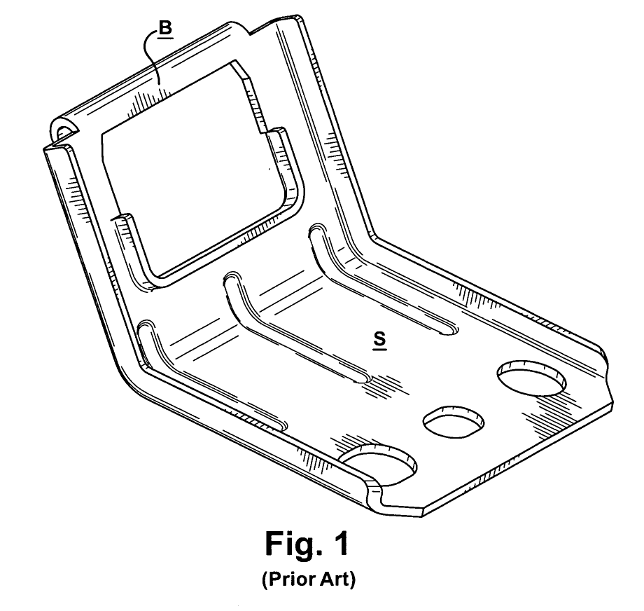

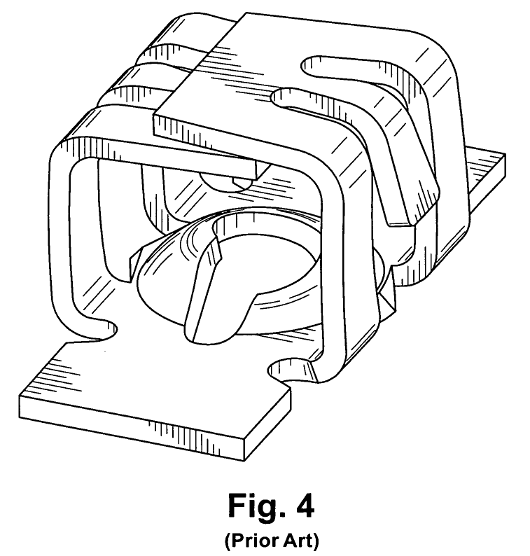

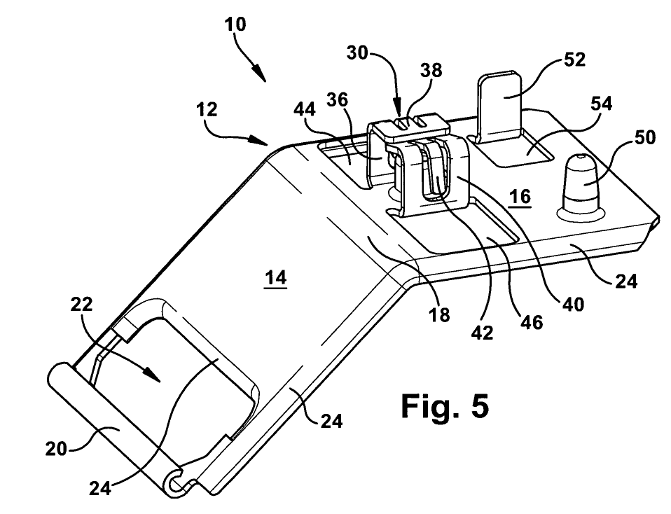

As generally described herein, the present invention provides a glove box striker 10. As illustrated in FIGS. 5-10, the glove box striker 10 may combine the function of typical prior art strikers, such as the ones shown in FIGS. 1-3, with the attachment capabilities of a prior art box clip, as can be seen in FIG. 4, into a one-piece component or one-piece stamping. This combination eliminates the need for additional fasteners, such as a weld nut or the like, as well as eliminates the need for any secondary operations, such as welding or the like, which both result in cost savings. Unlike the prior art, the striker 10 eliminates welding operations at the original equipment manufacturer (OEM), eliminates wire for the striker, and eliminates weld nuts for attachment, while also speeding up assembly time and lowering production costs.

Referring to FIGS. 5-10, an embodiment of a glove box striker 10 is shown. The striker 10 may include a body 12 that may serve as a mounting structure. The body 12 may include an integrally formed first body portion or end 14, a second body portion or end 16 and a bend 18. The bend 18 may be positioned at any appropriate location along the body 12, but is preferably located in a generally center location of the body 12, as shown in FIG. 5. In addition, the bend 18 is also preferably located between the first body portion 14 and the second body portion 16. The first body portion 14 may be located adjacent to and preferably at an angle A away from the second body portion 16, due to the bend 18. The angle A of the bend 18 may be of any appropriate degree, but is preferably an approximately 136-degree angle A, as best shown in FIG. 7.

As an alternative, instead of being an integrally formed body piece 12, the two body portions 14, 16 may be separate pieces that may be secured to one another by any appropriate means, including but not limited to welding, adhesive, mechanical fasteners, etc. and the like.

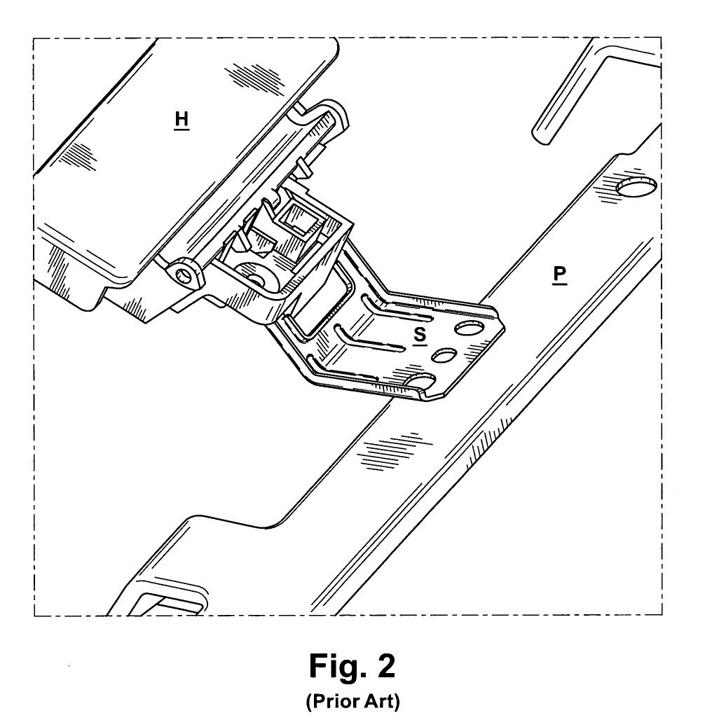

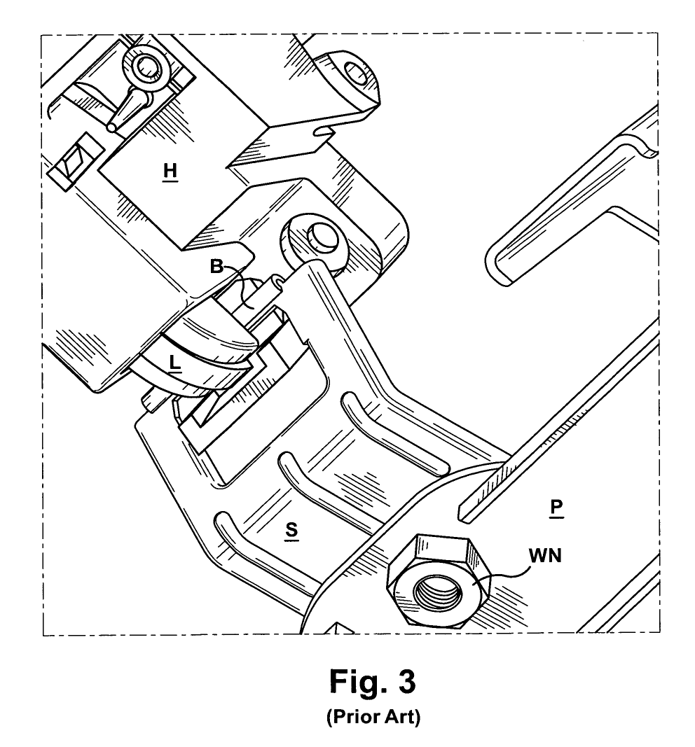

With further reference to FIGS. 5-10, the first body portion 14 of the striker 10 may also include a latch bar 20 and a latch opening 22. The latch bar 20 may be of any appropriate size or shape, but is preferably of a substantially linear shape forming a generally “C” shape in its profile, as best seen in FIG. 7. However, the latch bar 20 may be of any other appropriate shape or profile, such as a solid cylindrical rod shape. Preferably, the latch bar may be integrally formed to the striker 10, as shown in FIG. 5, however, the latch bar 20 may be a separate piece that needs to be attached to the striker 10. The latch bar 20 may be provided so that a catching mechanism of a glove box door may “strike” and close around the latch bar 20. A typical catching mechanism know in the art is illustrated in the prior art FIGS. 2 and 3.

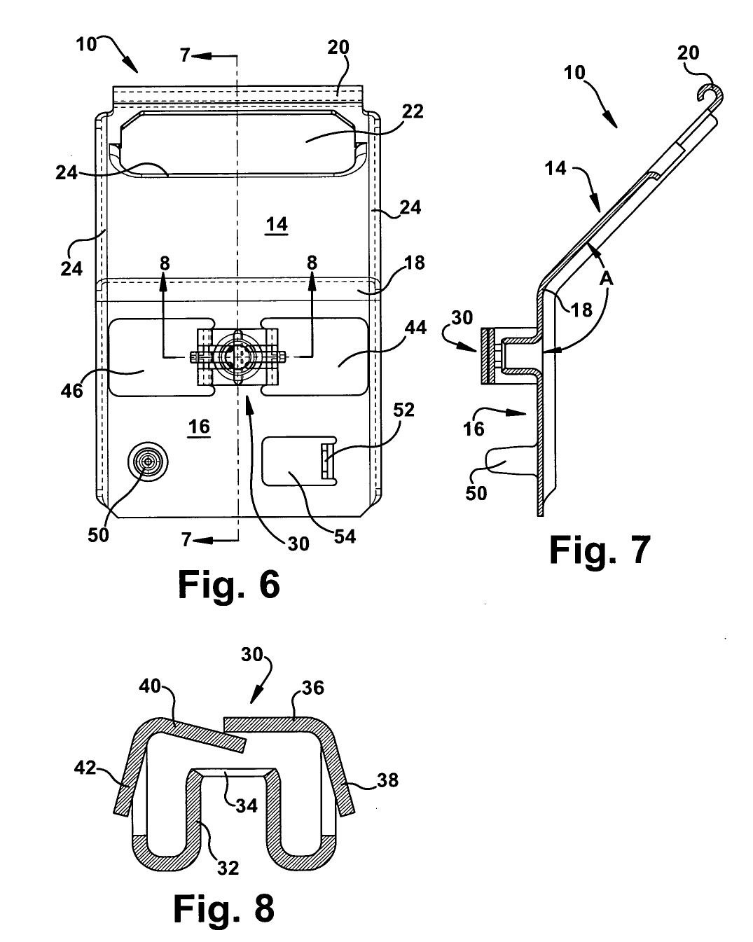

The latch opening 22 of the striker 10 may provide the “claw” of the catching mechanism room to catch and hold onto the latch bar 20. The latch opening 22 may be of any appropriate size or shape, but is preferably of a generally rectangular shape. The striker 10 may further include a structural lip 24 for additional strength. This structural lip 24 may extend along the outer edges of the body 12 and along an inner edge of the latch opening 22, as best shown in FIG. 6.

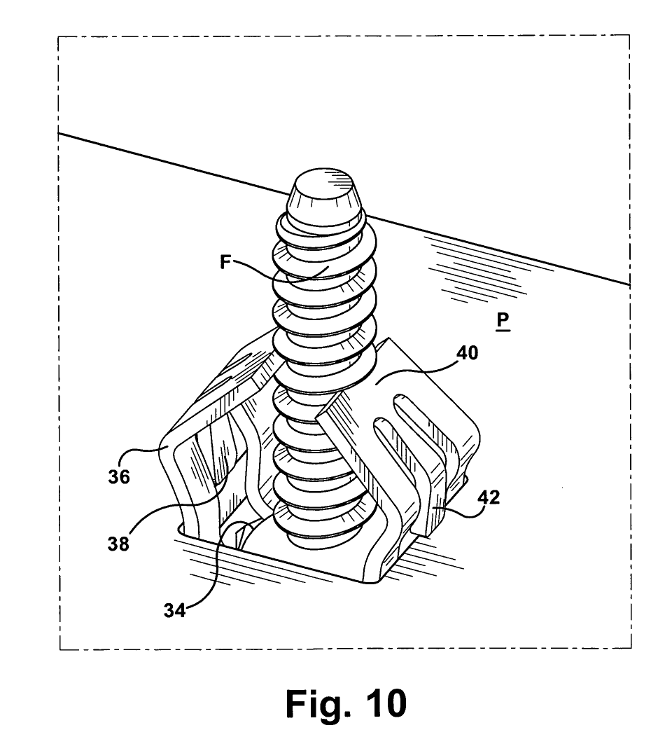

With additional reference to FIGS. 5-10, the second body portion 16 of the striker 10 may include a box clip feature 30. The box clip 30 may be positioned at any appropriate location on the striker 10, but is preferably located at the approximate center of the second body portion 16 and near the bend 18 area. The box clip 30 may include a first or upper wing 36 and a second or lower wing 40. As best shown in FIGS. 8 and 10, the first wing 36 may include a first tab 38 and the second wing 40 may include a second tab 42.

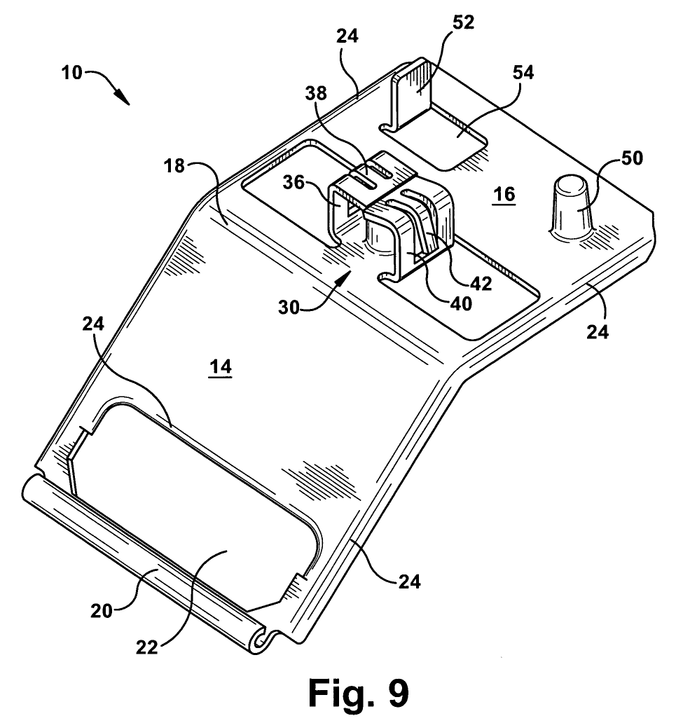

With reference to FIGS. 9 and 10, the first wing 36 may include a first tab 38. The first tab 38 may be integrally connected to the first wing 36 at its free end. In addition, the first tab 38 may be located at and extend from the approximate center of the free end of the first wing 36. While the first tab 38 is connected to and extends from the free end of the first wing 36, the first tab 38 is not connected to anything at its opposite end. This allows the free end of the first tab 38 to stop at and catch onto a structure, such as an instrument panel P or the like, as best shown in FIG. 10. In addition, there may be spaces located on either side of the first tab 38, so that the spaces may be located between the first tab 38 and either side of the first wing 36 to aid the first tab 38 in catching onto a structure, as discussed above.

Similarly, the second wing 40 may include a second tab 42. The second tab 42 may be integrally connected to the second wing 40 at its free end. In addition, the second tab 42 may be located at and extend from the approximate center of the free end of the second wing 40. While the second tab 42 is connected to and extends from the free end of the second wing 40, the second tab 42 is not connected to anything at its opposite end. This allows the free end of the second tab 42 to stop at and catch onto a structure, such as an instrument panel P or the like, as best shown in FIG. 10. In addition, there may be spaces located on either side of the second tab 42, so that the spaces may be located between the second tab 42 and either side of the second wing 40 to aid the second tab 42 in catching onto a structure, as discussed above.

Due to the formation of the first and second wings 36, 40 and the formation of the first and second tabs 38, 40, there may be a first wing opening 44 and a second wing opening 46 located on either side of the box clip feature 30 respectively. As shown in FIG. 6, the first wing opening 44 may be located between the first wing 36 and the structural lip 24, and the second wing opening 46 may be located between the second wing 40 and the structural lip 24 of the opposite side of the striker 10. In addition, the first wing opening 44 and the second wing opening 46 may be of any appropriate shape and seize, but are preferably of a generally rectangular shape, as shown in FIG. 6.

As best shown in FIG. 8, the box clip 30 may further include a raised boss 32 and a fastener opening 34. The raised boss 32 may be of any appropriate size or shape, but is preferably of a generally cylindrical shape, as shown in FIG. 8. The fastener opening 34 may be of any appropriate size or shape, but is preferably of a generally circular shape. The faster opening 34 is also preferably located at the top of the raised box 32, as shown in FIG. 8. The raised boss 32 and the fastener opening 34 are preferably located at the approximate center of the box clip feature 30 on the second body portion 16 of the striker 10. As may be best seen in FIGS. 5 and 8, when the box clip 30 is not engaged with a fastener F, the first and second wings 36, 40 of the box clip feature 30 are generally folded one on top of the other and the tabs 38, 42 are not engaged with the instrument panel P.

With reference to FIG. 10, the box clip feature 30 of the striker 10 may pass through an opening in the frame of an instrument panel P. A fastener F may be passed or extended through the fastener opening 34 of the box clip feature 30 of the striker 10. As the fastener F is passed or threaded through the fastener opening 34 the wings 36, 40 of the box clip feature 30 may expand as the fastener F is threaded into the box clip 30, in order to mount and secure the striker 10 to a surrounding structure. The surrounding structure may be, for example, an instrument panel P of an automobile body or the like. The fastener F may be of any appropriate type or means, but is preferably a screw, bolt, or the like. For example, as the fastener F is threaded into the fastener opening 34 of the box clip 30, the fastener F may push and correspondingly spread out the first and second wings 36, 40 so that the first and second wing tabs 38, 42 may catch on to the frame of the instrument panel P, or the like, and thus dramatically increases retention, as illustrated in FIG. 10.

With reference to FIGS. 5-9, and as an alternative embodiment, the second body portion 16 of the glove box striker 10 may also preferably have one or more locating features. These locating features may include a locating knob 50 and a locating tab 52. The locating knob 50 may be positioned at any appropriate location on the striker 10, but is preferably located on the second body portion 16 and toward the end of the second body portion 16, as shown in FIGS. 5-7 and 9. In addition, the locating knob 50 is preferably located towards one side of the striker 10 as well. The locating knob 50 may be of any appropriate size or shape, but is preferably of a generally cylindrical and cone like shape extending away from the surface of the striker 10.

With further reference to FIGS. 5-9, the locating tab 52 may be positioned at any appropriate location on the striker 10, but is also preferably located on the second body portion 16 and toward the end of the second body portion 16, as shown in FIGS. 5-7 and 9. In addition, the locating tab 52 is preferably located towards the opposite side of the striker 10 away from the locating knob 50. The locating tab 52 may be of any appropriate size or shape, but is preferably of a generally rectangular shape that extending away from the surface of the striker 10. Preferably, the locating tab 52 extends in a similar direction away from the surface of the striker 10 as the locating knob 50, but one will appreciate that the locating knob 50 and locating tab 52 may extend in either direction away from the striker 10.

Additionally, there is a tab opening 54 located adjacent to the locating tab 52. The tab opening 54 may be of any appropriate size or shape, but is preferably of a correspondingly similar size and shape to the locating tab 52. As another alternative, the locating features 50, 52 may be utilized as an additional mounting structure or surface through which fasteners may be passed or extended to mount and secure the striker 10 to a body.

The utilization of the locating knob 50 and locating tab 52 may further reduce the amount of handling and eliminate the need for additional welding operations, thus resulting in further cost savings. One of ordinary skill in the art will appreciate that these locating features 50, 52 may be of any other appropriate shape or appropriate means and that there may be only one or one or more locating features on the striker 10.

The embodiments of the invention have been described above and, obviously, modifications and alternations will occur to others upon reading and understanding this specification. The claims as follows are intended to include all modifications and alterations insofar as they come within the scope of the claims or the equivalent thereof.

Having thus described the invention, we claim:

1. A striker for mounting to a support structure and for engagement with a latch mechanism, said striker comprising:
a body having a first end and a second end;
a latch bar located on said first end;
at least one locating feature extending outwardly from said second end, wherein said locating feature is capable of engaging a support structure; and
an attachment feature capable of engaging the support structure.

2. The striker of claim 1 further comprising a bend located between said first end and said second end.

3. The striker of claim 1 further comprising a structural lip located around the outer edge of said body.

4. The striker of claim 1, wherein said attachment feature is a box clip.
